(19) United States
(12) Patent Application Publication
(10) Pub. No.: US 2009/0182671 A1
(43) Pub. Date: Jul. 16, 2009

(54) Interface system for annuity database for management of assets

(75) Inventor: Cornelius Petrus (Peter) Kloppers, Newport (AU)

Correspondence Address: COMPUTER PATENT ANNUITIES NORTH AMERICA, LLC;C/O CPA GLOBAL, P.O. BOX 52050, MINNEAPOLIS, MN, 55402, US

(73) Assignee: COMPUTER PATENT ANNUITIES LIMITED, St. Heilier (GB)

(21) Appl. No.: 12/332,011

(22) Filed: Dec. 10, 2008

Related U.S. Application Data
(60) Provisional application No. 60/996,867, filed on Dec. 10, 2007.

(51) Int. Cl. G06Q 50/00; H04L 9/32

(52) U.S. Cl. 705/51

(57) ABSTRACT

A method, system, and article are provided for extending the functionality of a patent management tool to incorporate automated submission of patent documents to a government agency. Due dates for documents submission is tracked by the management tool. Prior to expiration of a due date, appropriate documents are electronically submitted to the government agency. The document submission is automated without intervention of a patent practitioner. Following a submission without errors, a receipt is generated and communicated to the patent management tool. Data from the receipt is integrated into the patent management tool to track further requirements for the underlying subject patent asset.

### BACKGROUND OF THE INVENTION

1. Technical Field

This invention relates to electronic submission of patent documents to an electronic patent submission application. More specifically, the invention relates to an automated system for document submission that mitigates intervention from a practitioner.

2. Description of the Related Art

A patent is an exclusive right granted by a government to an inventor to manufacture, use, or sell an invention for a limited number of years. In order to obtain a patent grant, an applicant must submit an application before the domestic patent office for examination. More specifically, all U.S. applicants submit their applications for examination before the U.S. Patent and Trademark Office (PTO). Conventionally, there have been two mediums employed for submission of new applications before the PTO, including by hand delivery to the PTO facility, and through the U.S. Postal Service. Similarly, once an application has been submitted, all future papers related to the application that may need submission may be delivered to the PTO via hand delivery, the United States Postal Service, and facsimile.

As technology progresses, so has the avenue for submission of original patent application filings and subsequent papers before the PTO. In recent years, the PTO has made available to applicants a web service that supports electronic submission of all original applications as well as subsequent papers through standard Internet browser applications. The web service is known in the art as EFS Web. More specifically, EFS-Web is the PTO's web based patent application and document submission solution to the conventional papers filing avenues. Using EFS-Web, anyone with a web enabled browser accessible on their computer can file patent applications and documents without downloading special software or changing document preparation tools and processes.

EFS-Web utilizes standard web-based screens and prompts to enable applicants to submit patent application documents in portable document format (PDF) directly to the PTO. More specifically, the applicant creates PDF documents and then submits them to PTO=s secure servers. EFS-Web also supports submission of International patent cooperation treaty (PCT) applications and text files to submit bio-sequence listings, computer program listings, mega tables, etc. Following submission of one or more documents, EFS-Web provides an electronic receipt that acknowledges the documents submitted together with the submission date.

As user-friendly as EFS-Web appears to be to the applicant, there are drawbacks associated therewith. More specifically, when an applicant submits one or more documents via EFS-Web, they must categorize each document based upon a selection of categories provided. Each item that is submitted requires that the applicant review the list of categories for submission, select the appropriate category, and then attach the document for submission. There is no automated tool that enables the document to be uploaded, and properly categorized and attached to EFS-Web without manual intervention from the applicant.

There are various software tools that are employed by patent professionals to facilitate management of patent applications. It would be desirable to expand the functionality of one or more of the tools to support automated submission of patent documents to EFS-Web. Such tool would enhance the functionality of patent application management by submitting all documents directly to the PTO via EFS-Web, thereby mitigating loss of rights or fees associated with late submission of documents.

### SUMMARY OF THE INVENTION

This invention comprises an article and system for automating submission of patent documents to a government agency.

In one aspect of the invention, an article is provided to automate electronic filing of patent documents from a data storage medium. One or more patent related electronic documents for a patent application are submitted to a patent electronic filing application in an automated fashion. An application to support the automated submission includes instructions execution in a data storage medium. Among the instructions are instructions to compile at least one document in an electronic format acceptable by a recipient server and to store the document in a recordable data storage medium. This includes associating patent account information with the document. Instructions are also provided to detect a due date for submission of the compiled document, and to retrieve the compiled document in response to the due date detection. In addition, instructions are provided to extract account information associated with the retrieved document, and to request login into an electronic account associated with the document based on the extracted account information. This includes submission of a digital certificate and an associated valid password for the associated account on the recipient server. In response to a successful login request, instructions are provided to automatically extract case details from the compiled document and to populate appropriately marked fields of a patent submission application executing on the recipient server with the extracted case details from the compiled document. A receipt is generated and electronically returned to a client machine in communication with the recipient server responsive to completion of the case detail extraction and population, and valid submission of the compiled document to the patent submission application.

In another aspect of the invention, a computer system is provided with a client machine with a processor unit in communication with memory. A request manager is provided in communication with the hardware elements to monitor a submission deadline of at least one patent related electronic document for a patent application to a patent electronic filing application. Complementary to the request manager, an integration manager is provided in communication with the request manager and responsive to receipt of a communication from the request manager with an indication of the submission deadline prior to the deadline. The integration manager receives a compilation of at least one document in an acceptable electronic format from a storage device and in communication with the processor, and extracts account information associated with the retrieved document. Furthermore, the integration manager requests login into an electronic account associated with the document with the extracted account information, including submission of a digital certificate and an associated valid password for the account on the recipient server. In response to a successful login request, the integration manager automatically extracts case details from the compiled document and populates appropriately marked fields of a patent submission application executing on the recipient server with the extracted case details from the compiled document. A receipt is generated and electronically returned to a client machine in communication with the recipient server in response to completion of the case detail extraction and population, and valid submission of the compiled document to the patent submission application.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a block diagram of components of a tool for automating submission of patent documents to a government agency according to the preferred embodiment of this invention, and is suggested for printing on the first page of the issued patent.

FIG. 2 is a flow diagram demonstrating uploading of a document submission.

FIG. 3 is a flow diagram illustrating submission of the document and coordination with an external management tool.

FIG. 4 is a flow diagram illustrating processing of errors generated by the document submission.

FIG. 5 is a block diagram illustrating placement of the managers as hardware tools in a computer system.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for execution by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of request manager, integration manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

A submission tool is provided to enable users of a patent management tool to electronically file document with the PTO from within the patent management tool. More specifically, the patent management tool is in communication with a database for organizing and storing documents pertaining to one or more applications registered with the patent management tool. The submission tool extracts all relevant documents from the database, and electronically submits them to the EFS-Web. Following a completed submission, an electronic receipt is generated by EFS-Web, and returned to the integration manager. Data associated with the receipt is integrated into the patent management tool. Accordingly, the functionality of the patent management tool is extended to support submission of documents, and to integrate confirmation of the submission into management of the patent assets.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

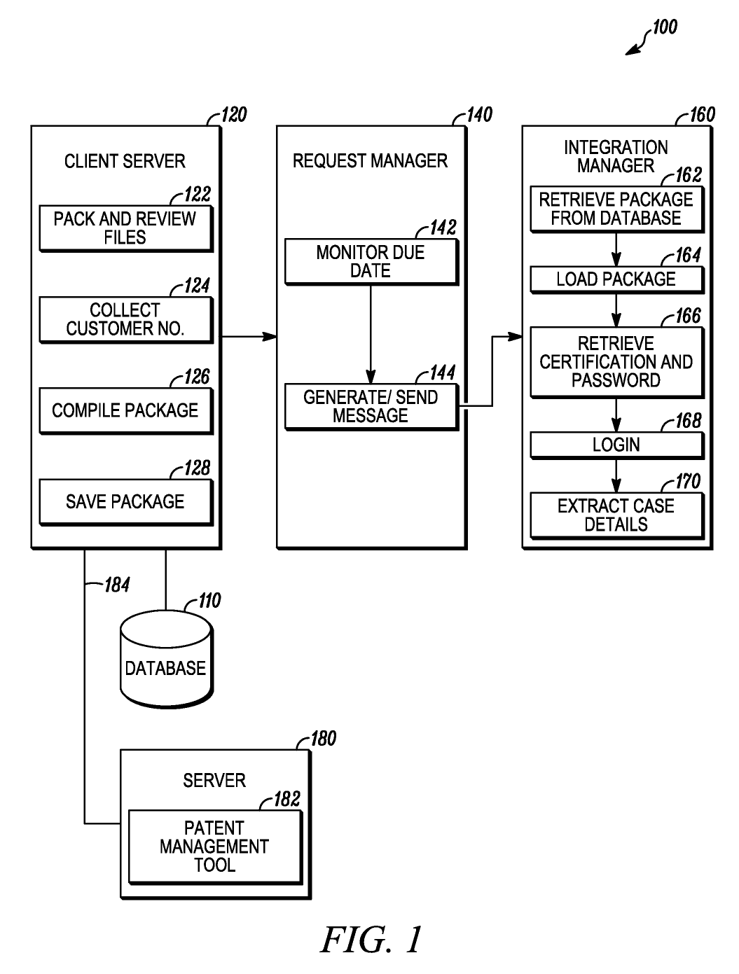

There are three primary components that are employed to support the automated EFS-Web submission of one or more patent documents. In this disclosure, an individual document is an electronic document which represents a particular physical/tangible document, including both before and/or after the physical/tangible document is converted to an/or from electronic form. FIG. 1 is a block diagram (100) illustrating the components and their relationship to the database. More specifically, the components include the database (110), a client server (120), a request manager (140), and an integration manager (160). Each of the components is employed and responsible for completing a portion of the document submission. The client server (120) is responsible for packing and reviewing the files required for filing with EFS-Web (122). In one embodiment, the files may be in extensible markup language (XML) or PDF format. Each patent practitioner who elects to submit their documents to the PTO via EFS-Web is required to have a digital certificate and associated authentication password. Authentication is conducted prior to filing, with the digital certificate obtained from the PTO prior to an independent of accessing EFS-Web. In one embodiment, the packing and review process includes adding details pertaining to the application to the package. Different tools may be embodiment to compile the package. In one embodiment, the compiled package may be in a zip format.

Following step (122), customer number information associated with the subject application is collected (124). In a similar manner to the digital certificate and password, upon request, the PTO issues a customer number to a practitioner or group of practitioners. Each application to be filed or currently pending through EFS-Web is associated with a customer number. The customer number, together with the digital certificate and authentication password is added to the compiled package (126). Accordingly, the client server (120) is responsible for compiling the package with all of the items necessary to complete a patent submission.

After creating the package, the client server (120) saves the package in the database (110) until an event triggers the electronic filing process at a future date (128). In one embodiment, the future electronic filing will occur on the future date specified. However, the invention should not be limited to this date. As in one embodiment, the event may specify that the future electronic filing occur at any time or at a specified date prior to the date specified in the event.

As shown in FIG. 1, the client server (120) is in communication with a request manager (140). In one embodiment, the request manager is an application that is local to the client server. However, in another embodiment, the request manager may be on a remote client or server that is in communication with the database that stores the compiled application document(s). The request manager (140) monitors due dates (142) that are tracked in a patent management tool (182). As shown herein, the patent management tool (182) is an application that is stored on a remote server (180) that is in communication with the client server (120) across a network connection (184). More specifically, the request manager (140) monitors the system for electronic filing events that become due. As demonstrated with respect to the client server (120) and compilation of patent documents, the client server (120) may create a due date event. When a new due date event is detected, the request manager (140) sends a message (144) to the integration manager (160) to perform the filing process for the compiled patent documents associated with the due date event. In one embodiment, the request manager (140) maintains a history of status of events. For example, the history may include a successful processing of a request, and different forms of errors. Accordingly, the request manager (140) is responsible for monitoring events due as set by the client server (120), and for communicating an event due message to the integration manager (160).

The client server (120) is in communication with the integration manager (160) through the request manager (140). As described briefly, the integration manager is responsible for submission of the document filing to EFS-Web. Following receipt of the event message, the integration manager (160) initiates the process of submitting an application to the PTO. The integration manager retrieves the package of compiled documents from the database (162) and loads the received package (164). As described above with respect to the compilation of the documents, the package includes the customer number for the practitioner, case data, and documents in PDF format. The integration manager (160) extracts the customer number from the package and uses it to retrieve the digital certificate and authentication password (166). In one embodiment, the integration manager employs a program in the form of a browser or browser host to perform the extraction step (166). Accordingly, the first part of the submission process for the integration manager is to extract the certificate, password, and customer number that are employed with the electronic submission of the subject document(s).

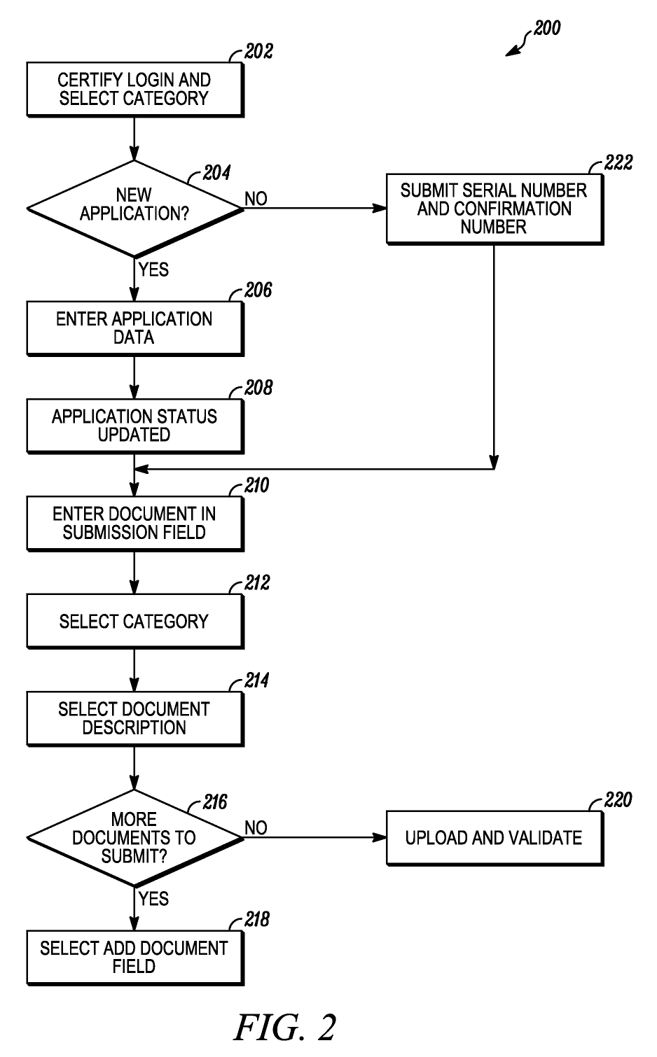

Once the certificate and password are extracted, the integration manager employs them together with the customer number to sign onto the EFS-Web (168). Details of the document submission following login are shown herein in FIG. 2, which is a flow diagram (200) demonstrating a document submission. Following submission of the certificate and associated authentication password, the manager extracts case details from the document package and populates the appropriate pages and fields of the patent submission application (170). More specifically, the manager certifies the login and selects the appropriate category of the subject document(s) (202). In one embodiment, the selection determines whether the submission is a new application or a pending application, and within the new application, the general subject matter of the application, such as utility, design, international, etc. Following step (202), the submission process of the document continues. If the document submission is a new application filing (204), the manager proceeds to enter application data to the patent submission application (206). In one embodiment, data entry includes, but is not limited to, the title of the invention, the attorney docket number, the first, middle, and last name of the first named inventor, and the customer number for the practitioner responsible for the submission of the application. Once step (206) is complete, the status of the application is updated on EFS-Web to application data (208), and the manager proceeds to attach the documents that are the subject of the submission. Conversely, if the document submission is an existing application, the manager submits the associated application number and confirmation number (222).

There are three fields that are employed for the document submission, including a field for the document to be submitted, the category of the submitted document, and an appropriate document description. The manager enters the document in the submission field (210), selects a relevant category (212), and selects a relevant document description (214). In one embodiment, either or both of the category and document description employ a selection tool to accommodate a proper selection. Following the selects at steps (210), (212), and (214), the manager determines if there more documents to submit with the submission (216). A positive response to the determination at step (216) is followed by the manager simulating selection of an Add Document field (218), followed by a return to step (206). Conversely, a negative response to the determination at step (212) is followed by the manager simulating selection of a button to upload and validate the attached document (220). The simulation at step (220) does not ensure that all of the selected documents have been successfully uploaded.

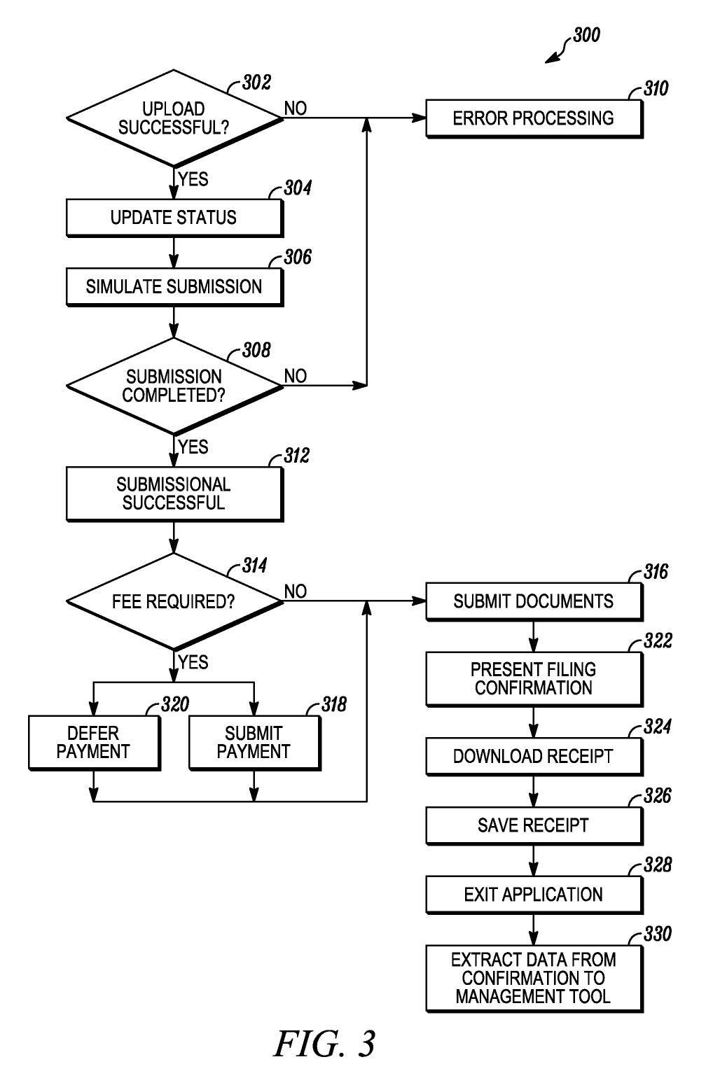

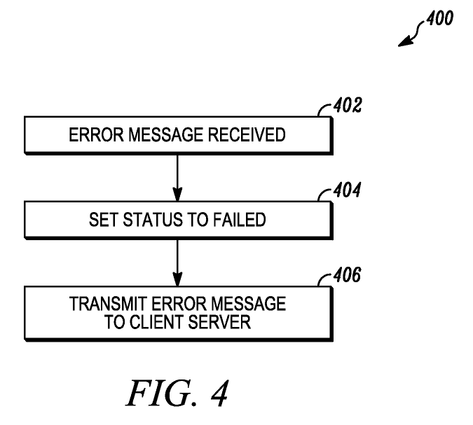

FIG. 3 is a flow chart (300) illustrating uploading of one or more documents to the submission application. Following step (220), it is determined if all of the documents selected for upload have been successful (302). In one embodiment, a successful upload is reflected by a pass message communicated from EFS-Web, and an unsuccessful upload is reflected by a fail message communicated from EFS-Web. A positive response to the determination at step (302) is followed by an update of the status of the package to reflect the success (304). In one embodiment, a successful upload is reflected by a document uploaded message from EFS-Web. Conversely, a negative response to the determination at step (302) is followed by error processing (310), shown in detail in FIG. 4.

Once all of the documents have been successfully attached, the manager simulates submission of the documents to the EFS-Web (306). In one embodiment, a submission is conducted through simulation of a submit button. However, a simulation of the submission does not guarantee that the submission is completed. A determination is conducted to determine if the submission is properly completed (308). If the response to the determination at step (308) is negative, the manager proceeds to error processing (310) as shown in detail in FIG. 4. Conversely, if the response to the determination at step (308) is positive, EFS-Web updates the status of the documents submitted to reflect a successful submission (312). In one embodiment, the EFS-Web generates an application submitted message.

Once the documents from the package are successfully submitted to EFS-Web, it is determined if the document submission requires a fee (314). If there is no fee required, the application manager simulates actuation of a submit button (316) and the documents are successfully submitted to EFS-Web. Conversely, if a fee is required, the application manager is presented with two options, to submit payment with the submission (318), or to submit the documents with payment deferred (320). Selection of a concurrent payment is followed by presentation of payment options to the manager. Following submission of payment instructions of the deferred payment at step (320), the application manager simulates actuation of a submit button (316), and following a successful upload, the manager is presented with a filing confirmation (322).

The presentation of a filing confirmation is not a documented filing receipt. The manager must request download of a filing receipt from EFS-Web (324). Once the document is downloaded, the manager saves the filing receipt in the associated database (326) and exits the patent submission application (328). As reflected at step (320), a payment may be required but not submitted. Under such circumstances, the database will reflect the deferred payment status to be associated with the application data in the patent management tool. Essentially, data associated with the submission is extracted form the confirmation and integrated into the patent management tool (330) to ensure that further tasks required for the underlying patent asset are properly tracked and managed. Accordingly, the status of the submission is reflected in the patent management database local to the database.

The process of submitting and simulating document submission to EFS-Web may encounter errors. FIG. 4 is a flow diagram (400) illustrating processing of such errors. In general, the error processing is similar for the different stages of document upload and submission. The manager receives an error message following submission of a portion of the document (402), and the status of the submission is set to failure (404). A message is transmitted to the client server manager with the error message to rebuild the document submission package to correct the basis for the error (406). In one embodiment, the manager communicates an electronic mail message to the user associated with the document submission indicating the failure of the document submission. Similarly, in one embodiment, EFS-Wed displays error message on top of the web page and also directly under the corresponding field when an error is encountered. Error message are typically displayed when a required field is not populated or documents to be uploaded are invalid. In one embodiment, a failure message will appear if the attached PDF document fails the validation. Accordingly, a failure message encompasses the failure of the document to be successfully uploaded and submitted to EFS-Web.

It should be noted that a failure message, as demonstrated in FIG. 4, is not equivalent to a warning message. A warning error reflects items in the documents that are acceptable, but are not preferred. Examples of error prone items include, but are not limited to: page size, selected fonts, and whether a document is an acceptable fillable form. Warning errors do not cause the workflow to stop and reset by the client server. In one embodiment, the warning error generates an electronic message sent to the user associated with the document submission indicating the basis for the warning.

There are several underlying requirements to support the integration manager. Outside of the integration manager, EFS-Web is only available to practitioners that are registered with EFS-Web. Accordingly, each practitioner or group of practitioners must obtain a customer number, a digital certificate, and an associated authentication password prior to utilizing EFS-Web.

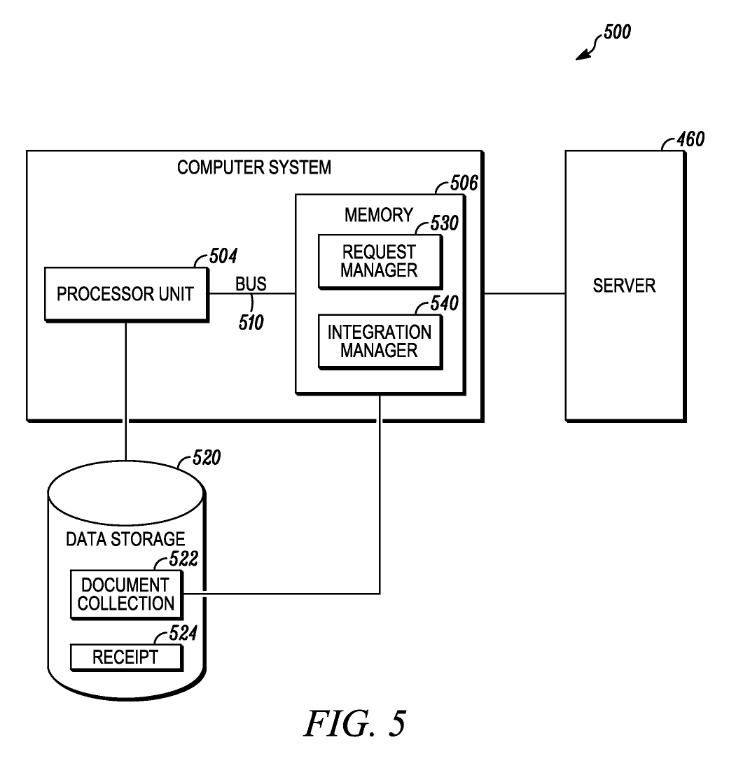

FIG. 5 is a block diagram (500) illustrating placement of the managers as hardware tools in a computer system. The illustration shows a computer system (502) with a processor unit (504) coupled to memory (506) by a bus structure (510). Although only one processor unit (504) is shown, in one embodiment, the computer system (502) may include more processor units in an expanded design. The computer system includes data storage (520) in communication with the processor unit (504). The data storage unit is employed for retention of a collection of documents (522). In one embodiment, the collection of documents is patent application documents.

A request manager (530) is provided in communication with the system (502). However, in one embodiment, the request manager may be on a remote system (not shown) that is in communication with the system (502) across a network. The request manager (530) monitors submission deadlines associated with the collection patent application documents (522) retained on the data storage (520) in communication with the system (502). Upon detection of a deadline, also known as a due date, the request manager generates a message and communicates the message to an integration manager (540). As with the request manager, the integration manager may be local to the system (502) or on a remote system (not shown) that is in communication with the system (502) across a network. The integration manager (540) is also in communication with the collection of documents (522) retained on the data storage (520). More specifically, the integration manager (540) is responsible for loading the document(s) subject to the submission deadline, extracting the customer number, digital certificate, and password associated with the subject document(s), and properly attaching them to the patent submission application on a remote server (560). The system (502) is in communication with the remote server (560) across a network connection.

Following a successful submission of a document to the patent submission application on the remote server (560), a receipt (524) is generated. The receipt (562) is an electronic document which represents a physical/tangible document verifying receipt of submission of the subject document(s) to the patent submission application. In one embodiment, the generated receipt is returned to the system (502) in response to completion of the document submission process. The generated receipt is demonstrative of the valid submission of the compiled patent documents to the patent submission application.

As shown herein, the request manager (530) and the integration manager (540) each reside in memory (506) local to the computer system (502). In one embodiment, each of the managers (530) and (540) may reside as hardware tools external to local memory (506), or may be implemented as a combination of hardware and software. Similarly, in one embodiment, the managers (530) and (540) may be combined into a single functional item that incorporates the functionality of the separate items. Furthermore, as shown herein each of the managers (530) and (540) are local to the computer system (502). However, in one embodiment they may be collectively or individually distributed across a network and function as a unit to support automated submission of patent documents. Accordingly, the managers (530) and (540) may be implemented as software tools, hardware tools, or a combination of software and hardware tools.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

One or more manager and/or tools are provided to support automated submission of patent related documents to a patent submission application. Due dates are monitored to ensure submission of the necessary documents to avoid payment of late fees, meeting deadlines, and/or abandonment of a pending application. Intervention by a patent practitioner is mitigated, and limited to documents that fail the submission process. Efficiency in patent prosecution is achieved and overhead is mitigated by removing the task of document submission from a patent practitioner to hardware and/or software tools.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. An article for automating electronically filing of patent documents from a data storage medium, comprising:
automating submission of one or more patent related electronic documents for a patent application to a patent electronic filing application, including an application executing instructions in a data storage medium, the instructions comprising:
instructions to compile at least one document in an electronic format acceptable by a recipient server and to store the at least one document in a recordable data storage medium in communication with a client machine, including associating patent account information with the at least one document;
instructions to an application in communication with the client machine to detect a due date for submission of the compiled document;
instructions to retrieve the compiled document in response to the due date detection;
instructions to extract account information associated with the retrieved document;
instructions to request login into an electronic account associated with the document with the extracted account information, including submission of a digital certificate and an associated valid password for the account to the recipient server; and
responsive to a successful login request, instructions to automatically extract case details from the compiled document and populate appropriately marked fields of a patent submission application executing on the recipient server with the extracted case details from the compiled document;
a receipt generated and electronically returned to a client machine in communication with the recipient server responsive to completion of the case detail extraction and population, and valid submission of the compiled document to the patent submission application.

2. The article of claim 1, further responsive to a successful login request and field population submission, instructions to automatically attach the compiled document into one or more appropriately marked fields.

3. The article of claim 2, further comprising instructions to repeat the field population and attachment of each document, including automatically attaching each successive document into respective appropriately marked fields.

4. The article of claim 3, further comprising instructions to upload and validate each attached document.

5. The article of claim 4, further comprising instructions to review a returned status for each uploaded and validated document, and confirm submission of the documents responsive to return of a successful returned status.

6. The article of claim 5, further comprising instructions to return an electronic message to the client machine responsive to receipt of a returned fail status of any uploaded compiled document.

7. The article of claim 5, further comprising sending an electronic communication reminder to the client machine in response to a failure to upload any one of the compiled documents in the package.

8. The article of claim 1, further comprising instructions to verify submission of the documents.

9. The article of claim 9, further comprising instructions to create an extensible markup language (XML) formatted file for storing the receipt of submission, sending the XML formatted receipt to the client machine, and storing the XML formatted file in a data storage medium in communication with the client machine.

10. The article of claim 1, wherein the instructions to compile the at least one document includes associating the document with a patent application category field and a document description field as provided in the patent submission application executing on the recipient server.

11. The article of claim 10, wherein the instructions to extract case details from the document and populate appropriately marked fields in the patent submission application with extracted data includes selecting a relevant category from a category selection option in the patent submission application executing on the recipient server.

12. The article of claim 11, wherein the instructions to populate appropriately marked fields includes selecting a relevant description from a document description section in the patent submission application executing on the recipient server.

13. The article of claim 1, wherein the instructions to retrieve the document from the data storage medium in communication with the client machine in response to the due date detection is prior to the occurrence of the due date.

14. The article of claim 1, further comprising instructions to extract data from said receipt and to communicate the extracted data to a tool in communication with the data storage medium.

15. A computer system comprising:
a client machine with a processor unit in communication with memory;
a request manager in communication with the memory, the request manager to monitor a submission deadline of at least one patent related electronic document for a patent application to a patent electronic filing application;
an integration manager in communication with the request manager and responsive to receipt of a communication from the request manager indicating the submission deadline prior to the deadline, the integration manager to:
receive a compilation of at least one document in an electronic format acceptable from a storage device and in communication with the processor,
extract account information associated with the retrieved document;
request login into an electronic account associated with the document with the extracted account information, including submission of a digital certificate and an associated valid password for the account to the recipient server; and
responsive to a successful login request, automatically extract case details from the compiled document and populate appropriately marked fields of a patent submission application executing on the recipient server with the extracted case details from the compiled document;
a receipt generated and electronically returned to a client machine in communication with the recipient server responsive to completion of the case detail extraction and population, and valid submission of the compiled document to the patent submission application.

16. The system of claim 1, further responsive to a successful login request and field population submission, the integration manager to automatically attach the compiled document into one or more appropriately marked fields.

17. The system of claim 16, further comprising the integration manager to repeat the field population and attachment of each document, including automatically attaching each successive document into respective appropriately marked fields.

18. The system of claim 17, further comprising the integration manager to upload and validate each attached document.

19. The system of claim 18, further comprising the recipient server to return an electronic message to the client machine responsive to receipt of a returned fail status of any uploaded compiled document.

20. The system of claim 15, further comprising the integration manager to verify submission of the documents.

21. The system of claim 15, wherein the integration manager compiles the at least one document associating the document with a patent application category field and a document description field as provided in the patent submission application executing on the recipient server.

22. The system of claim 21, wherein the integration manager extracts case details from the document and populates appropriately marked fields in the patent submission application with extracted data including selection of a relevant category from a category selection option in the patent submission application executing on the recipient server.

23. The system of claim 22, wherein the integration manager populates appropriately marked fields including selection of a relevant description from a document description section in the patent submission application executing on the recipient server.

24. The system of claim 15, wherein the integration manager retrieves the document from the data storage medium in communication with the client machine in response to the due date detection prior to the occurrence of the due date.
